(19) United States
(12) Patent Application Publication
(10) Pub. No.: US 2020/0307788 A1
(43) Pub. Date: Oct. 1, 2020

(54) SYSTEMS AND METHODS FOR AUTOMATIC WATER SURFACE AND SKY DETECTION

(71) Applicant: SZ DJI TECHNOLOGY CO., LTD., Shenzhen (CN)

(72) Inventors: You ZHOU, Shenzhen (CN); Jianzhao CAI, Shenzhen (CN); Ketan TANG, Shenzhen (CN)

(21) Appl. No.: 16/900,521

(22) Filed: Jun. 12, 2020

Related U.S. Application Data
(63) Continuation of application No. PCT/CN2018/073864, filed on Jan. 23, 2018.

(51) Int. Cl. B64C 39/02; G01C 22/00; G01C 21/20; G06T 7/50; G06K 9/00; G05D 1/10; B64D 47/08

(52) U.S. Cl. CPC B64C 39/024; G01C 22/00; G01C 21/20; G06T 7/50; B64C 2201/141; G05D 1/106; B64D 47/08; G06T 2207/10032; B64C 2201/027; G06K 9/0063

(57) ABSTRACT

A method for processing image information in an image to determine a movement for a movable object. The method includes detecting whether the image includes a water surface or a sky based on the image information in the image, And, in response to detecting that the image includes the water surface or the sky, determining a technique from a plurality of techniques for calculating a depth map, generating the depth map using the technique, and determining a movement parameter for the movable object using the depth map.

### CROSS-REFERENCE TO RELATED APPLICATION

This application is a continuation of International Application No. PCT/CN2018/073864, filed Jan. 23, 2018, the entire content of which is incorporated herein by reference.

### TECHNICAL FIELD

The present disclosure generally relates to improved computer vision and image processing techniques and, more particularly, to systems and methods that may be used for improved detection of objects in images that are not rich in texture, such as corresponding to a region of an image depicting a water surface or an area of the sky.

### BACKGROUND

Movable objects, such as unmanned aerial vehicles (UAV) (sometimes referred to as “drones”), include pilotless aircraft of various sizes and configurations that can be remotely operated by a user and/or programmed for automated flight. Movable objects can be used for many purposes and are often used in a wide variety of personal, commercial, and tactical applications. For instance, movable objects may find particular use in surveillance, national defense, and professional videography industries, among others, and are also popular with hobbyists and for recreational purposes.

In many applications, movable objects may be equipped with secondary devices to perform various tasks. For instance, secondary devices may include imaging equipment, such as one or more cameras, video cameras, etc., that captures images or video footage that is difficult, impractical, or simply impossible to capture otherwise. Movable objects may use computer vision or other image signal processing techniques to analyze these captured images to detect objects within the images and/or complete important navigational tasks, such as braking, hovering, avoiding objects, etc. As used herein, a “movable object” may be any physical device capable of moving in real space; an “object” in an image may correspond to at least one identifiable region or feature depicted in the image, such as, for example, an identifiable area in the image corresponding to a person, animal, inanimate object or group of objects, particular terrain or geography (e.g., mountain, river, sun, etc.), feature of a larger object, etc.

Movable objects often use conventional stereovision techniques to analyze the captured images. For example, a movable object may use two or more cameras to capture a first set of images of a scene at a first instance in time and capture a second set of images of the scene at a second instance in time. The scene may be any input that can be detected by the cameras and depicted in a captured image. The movable object may calculate a stereographic depth map for the scene based on a comparison of the first and second sets of images and known positions of the cameras. The movable object may use the calculated depth map to further calculate one or more status information parameters (e.g., speed, position, direction, etc.) corresponding to the movable object and/or objects in the captured images, for example, to facilitate navigational tasks performed by the movable object.

There are, however, some drawbacks when movable objects use conventional stereovision techniques to analyze captured images to complete navigational tasks. These drawbacks typically occur because conventional techniques operate under the assumption that the captured images are rich in texture, i.e., rich in colors, contrast, brightness, sharpness, etc., that provide a clear distinction between different objects in the images. Thus, movable objects that use conventional stereovision techniques to capture images of a scene with objects and features that are not rich in texture, such as a region of a water surface or a sky, may calculate inaccurate depth maps, resulting in calculations of inaccurate visual odometry parameters needed to complete navigation tasks. These inaccurate depth maps may lead to undesirable results, such as the movable object crashing, braking prematurely, hovering erratically, etc.

There is a need for improved computer-vision techniques that may be used, for example in movable objects, to detect objects and features that are not rich in texture within scenes of captured images. The computer-vision techniques should be suitable for use in a multitude of computer vision applications, including but not limited to UAVs, object and pattern recognition, machine learning, material analysis, agriculture analysis, food analysis, robotics, autonomous driving, and any other systems that would benefit from detecting objects in scenes and/or images that are not rich in texture.

### SUMMARY

The present disclosure overcomes the disadvantages of the existing technologies by providing systems and methods that may be used in computer vision systems, including but not limited to such systems in movable objects, such as aerial vehicles and platforms, UAVs, cars, boats, and robots. Unlike prior implementations, the disclosed embodiments can detect objects that are not rich in texture within scenes of captured images, such as objects in the images corresponding to regions of a water surface or a sky. The disclosed embodiments improve existing systems and techniques using stereovision, for example, by enabling a movable object to accurately calculate depth maps and successfully complete navigation techniques, such as braking, hovering, avoiding objects, etc. The disclosed systems and techniques also may reduce unsatisfactory navigation, such as crashing, premature braking, erratic hovering, etc.

In certain disclosed embodiments, systems and methods for processing image information may be used to detect a sky (or portion thereof) depicted in an image. Such embodiments, for example, may include one or memory devices storing instructions for execution by a processor, and one or more processors that are coupled to the memory devices and operative to execute the instructions. The disclosed embodiments may obtain image information or capture such image information using one or more cameras, whether internal or external to the system. In some embodiments, for example, the system may obtain the image information by retrieving it from a database. The obtained image information may include data that represents the contents of the image, such as pixel information indicating values, such as red-green-blue (RGB) values, indicating the color of each pixel in the image. Pixel information values may also include local binary pattern (LBP) values to provide the texture of an image. Other values also may be included in the image information, such as an intensity of each pixel, a number of pixels, a position of each pixel, etc.

In some embodiments, the system may be configured to determine whether the image information represents and/or includes a sky (or portion thereof) based on a classification model. The classification model may be constructed using machine learning principles, such as supervised learning, semi-supervised learning, and/or unsupervised learning. To train the classification model to detect the sky, the system may be configured using training parameters, such as RGB values corresponding to pixels in the image, local binary pattern values, intensity values, etc.

Further to the disclosed embodiments, systems and methods for processing image information may be used to detect a water surface (or portion thereof) in first and second images. Such embodiments, for example, may include one or memory devices storing instructions for execution by a processor, and one or more processors that are coupled to the memory devices and operative to execute the instructions. In some disclosed embodiments, the one or more processors may be configured to execute instructions to detect, in a first image, a first edge line based on first image information, and further detect, in a second image, a second edge line based on second image information. Each edge line may be a linear or curvilinear line, path, or other boundary that can be detected in the first and second images. In some embodiments, the first and second edge lines may correspond to the same object or feature depicted in both the first and second images, i.e., the first edge line detected in the first image may correspond to the same edge line as the second edge line detected in the second image. In some embodiments, to detect an edge line, the one or more processors may be configured to detect first and second edge points in an image (e.g., the endpoints of an edge line or other identifiable points that may be located on an edge line) and compare the relationship between the first and second edge points with a predetermined relationship. The relationship between the first and second edge points may be, for example, the distance between the first and second edge points and/or any other difference that may be determined between the first and second edge points. In some embodiments, the one or more processors may be configured to superimpose the first image onto the second image to compare the relationship between the first and second edge points with a predetermined relationship.

In accordance with certain disclosed embodiments, systems and methods may be used to process image information in an image to determine a movement for a movable object. Such embodiments, for example, may include one or memory devices storing instructions for execution by a processor, and one or more processors that are coupled to the memory devices and operative to execute the instructions. The one or more processors may be configured to execute instructions to detect whether an image includes a water surface or a sky based on image information in the image. In some embodiments, the one or more processors may be configured to determine a technique from a plurality of techniques for calculating a depth map in response to detecting the water surface or the sky in the image. In some embodiments, the determined technique may be configured to modify cost parameters or other metrics for pixels in a region of the image corresponding to a detected water surface or sky, e.g., to set the cost parameters or other metrics equal to a predetermined value in the region. The cost parameters or other metrics may be modified, for example, if the detected water surface or sky is determined to have less than a threshold amount of texture. The one or more processors may determine a movement parameter for the movable object using the generated depth map.

The above-noted plurality of techniques may include, for example, one or more types of global matching, semi-global matching, or other techniques that map similar neighboring pixels in constructing a depth map for the image. In some embodiments, the one or more processors may be configured to determine to use a first particular technique, such as global matching, to create the depth map if a sky is detected and use a second particular technique, such as semi-global matching, to create the depth map if a water surface is detected. In some implementations that using semi-global matching, the plurality of cost parameters may indicate the cost of a pixel along each path to a neighboring pixel. In some embodiments, setting the pixels' cost parameters to a value indicating the pixels are in an area with little or no texture may allow the systems and methods to ignore image information corresponding to a detected water surface or sky with insufficient texture when generating the depth map. In such embodiments, the technique for generating the depth map instead may use calculated depths of pixels surrounding, or otherwise in the same vicinity as, the pixels corresponding to regions of a detected water surface or sky with insufficient texture to interpolate or otherwise estimate depths for those pixels in the low-texture regions.

Further, in some embodiments in which the image contains low-texture regions, such as corresponding to regions showing clear sky, clear water, mirrored surfaces reflecting a clear sky, etc., the disclosed systems and methods may modify or change the movable object's landing strategy and/or visual odometry calculation strategy. For example, when detecting that a water surface is located underneath the movable object as it is flying or hovering, e.g., based on images captured from at least one sensor or camera on the movable object, the movable object may change its landing strategy to ensure that it will continue flying or hovering and/or warning the user of the underlying water surface. In some embodiments, the movable object may change at least one odometry calculation strategy, for example, so it may calculate at least one of its position and orientation without using image data received from sensors or cameras mounted underneath the movable object or otherwise directed below the movable object.

According to certain embodiments, the disclosed systems and methods may be used to process image information in an image to adjust a navigation strategy for the movable object. Such embodiments, for example, may include one or memory devices storing instructions for execution by a processor, and one or more processors that are coupled to the memory devices and operative to execute the instructions. The disclosed embodiments may detect whether the image includes a water surface or a sky based on image information in the image. In addition, in response to detecting that the image includes the water surface or the sky, the disclosed embodiments may select a navigation strategy based on whether the water surface and/or the sky has been detected. For example, if the disclosed embodiments detect a water surface, the movable object may employ a navigation strategy (e.g., a landing strategy) such that the movable object may keep flying or hovering over the water surface. The disclosed embodiments also may perform a visual odometry calculation without using a depth map in response to detecting a water surface or a sky in the image. For example, if the disclosed embodiments detect a water surface below the movable object, the disclosed embodiments may perform one or more visual calculations without using a depth map and/or may ignore odometry calculations derived from image information in regions of the detected water surface to increase flying and hovering stability.

Aspects of the disclosed embodiments may include a non-transitory tangible computer-readable medium that stores software instructions that, when executed by the one or more processors, are configured for and capable of performing and executing one or more of the methods, operations, and the like, in accordance with the disclosed embodiments. It is to be understood that both the foregoing general description and the following detailed description are exemplary and explanatory only, and are not restrictive of the claims set forth herein.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a schematic diagram of an exemplary movable object configured to communicate with an exemplary second object that may be used in accordance with the disclosed embodiments;

FIG. 2 is a schematic block diagram of an exemplary control system that may be used in accordance with the disclosed embodiments;

FIG. 3 is a schematic block diagram of an exemplary flight control module that may be used in accordance with the disclosed embodiments;

FIG. 4 is a diagram of exemplary image capture process that may be used by a movable object as it moves in an exemplary environment in accordance with the disclosed embodiments;

FIG. 5A is a schematic diagram of an exemplary edge line that may be used in accordance with the disclosed embodiments;

FIG. 5B is a schematic diagram of an exemplary area that may be formed based on edge lines in accordance with the disclosed embodiments;

FIG. 6 is a flowchart of an exemplary water surface detection process that may be used in accordance with the disclosed embodiments;

FIG. 7 is a flowchart of an exemplary edge line detection process that may be used in accordance with the disclosed embodiments;

FIG. 8 is a flowchart of an exemplary area detection process that may be used in accordance with the disclosed embodiments;

FIG. 9 is a flowchart of an exemplary sky detection process that may be used in accordance with the disclosed embodiments; and

FIG. 10 is a flowchart of an exemplary water or sky detection process that may be used in accordance with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

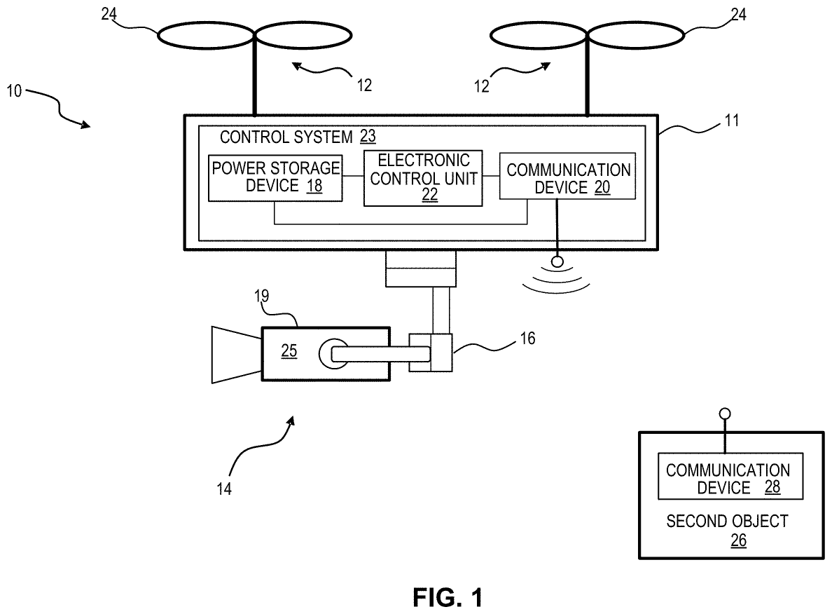

FIG. 1 shows an exemplary movable object 10 that may be configured to move within an environment. Movable object 10 may be any suitable object, device, mechanism, system, or machine configured to travel on or within a suitable medium (e.g., a surface, air, water, one or more rails, space, underground, etc.). For example, movable object 10 may be an unmanned aerial vehicle (UAV). Although movable object 10 is shown and described herein as a UAV for exemplary purposes of this description, it is understood that other types of movable objects (e.g., wheeled objects, nautical objects, locomotive objects, other aerial objects, an aerial vehicle, an aerial platform, an autonomous vehicle, a boat, a robot, etc.) may also or alternatively be used in embodiments consistent with this disclosure. As used herein, the term UAV may refer to an aerial device configured to be operated and/or controlled automatically (e.g., via an electronic control system) and/or manually by off-board personnel.

Movable object 10 may include a housing 11, one or more propulsion assemblies 12, and a payload 14, such as one or more camera systems. In some embodiments, as shown in FIG. 1, payload 14 may be connected or attached to movable object 10 by a carrier 16, which may allow for one or more degrees of relative movement between payload 14 and movable object 10. In other embodiments, payload 14 may be mounted directly to movable object 10 without carrier 16. Movable object 10 may also include a power storage device 18, a communication device 20, and an electronic control unit 22 in communication with the other components. In some embodiments, one or more of power storage device 18, communication device 20, and an electronic control unit 22 may be included in a control system 23. Control system 23 may be configured to control multiple systems or functions of movable object 10. Alternatively, control system 23 may be dedicated to controlling a single system or subset of functions. For example, control system 23 may be or include a flight control system of a UAV, which allows methods to control payload 14.

Movable object 10 may include one or more propulsion assemblies 12 positioned at various locations (for example, top, sides, front, rear, and/or bottom of movable object 10) for propelling and steering movable object 10. Although only two exemplary propulsion assemblies 12 are shown in FIG. 1, it will be appreciated that movable object 10 may include any number of propulsion assemblies (e.g., 1, 2, 3, 4, 5, 10, 15, 20, etc.). Propulsion assemblies 12 may be devices or systems operable to generate forces for sustaining controlled flight. Propulsion assemblies 12 may share or may each separately include at least one power source, such as one or more batteries, fuel cells, solar cells, etc., or combinations thereof. Each propulsion assembly 12 may also include one or more rotary components 24, e.g., within an electric motor, engine, or turbine, coupled to the power source and configured to participate in the generation of forces for sustaining controlled flight. For instance, rotary components 24 may include rotors, propellers, blades, etc., which may be driven on or by a shaft, axle, wheel, or other component or system configured to transfer power from the power source. Propulsion assemblies 12 and/or rotary components 24 may be adjustable (e.g., tiltable) with respect to each other and/or with respect to movable object 10. Alternatively, propulsion assemblies 12 and rotary components 24 may have a fixed orientation with respect to each other and/or movable object 10. In some embodiments, each propulsion assembly 12 may be of the same type. In other embodiments, propulsion assemblies 12 may be of multiple different types. In some embodiments, all propulsion assemblies 12 may be controlled in concert (e.g., all at the same speed and/or angle). In other embodiments, one or more propulsion devices may be independently controlled with respect to, e.g., speed and/or angle.

Propulsion assemblies 12 may be configured to propel movable object 10 in one or more vertical and horizontal directions and to allow movable object 10 to rotate about one or more axes. That is, propulsion assemblies 12 may be configured to provide lift and/or thrust for creating and maintaining translational and rotational movements of movable object 10. For instance, propulsion assemblies 12 may be configured to enable movable object 10 to achieve and maintain desired altitudes, provide thrust for movement in all directions, and provide for steering of movable object 10. In some embodiments, propulsion assemblies 12 may enable movable object 10 to perform vertical takeoffs and landings (i.e., takeoff and landing without horizontal thrust). In other embodiments, movable object 10 may require constant minimum horizontal thrust to achieve and sustain flight. Propulsion assemblies 12 may be configured to enable movement of movable object 10 along and/or about multiple axes.

Payload 14 may include one or more sensory devices 19, such as the exemplary sensory device 19 shown in FIG. 1. Sensory devices 19 may include imaging system 25. Sensory devices 19 may include devices for collecting or generating data or information, such as surveying, tracking, and capturing images or video of targets (e.g., objects, landscapes, subjects of photo or video shoots, etc.). Sensory devices 19 may include one or more imaging devices configured to gather data that may be used to generate images. For example, imaging devices may include photographic cameras (e.g., analog, digital, etc.), video cameras, infrared imaging devices, ultraviolet imaging devices, x-ray devices, ultrasonic imaging devices, radar devices, binocular cameras, etc. In some embodiments, the sensory devices 19 may include a one-dimensional or multi-dimension array of cameras and a plurality of bandpass filters as described further below. Sensory devices 19 may also include devices for capturing audio data, such as microphones or ultrasound detectors. Sensory devices 19 may also or alternatively include other suitable sensors for capturing visual, audio, and/or electromagnetic signals.

Carrier 16 may include one or more devices configured to hold the payload 14 and/or allow the payload 14 to be adjusted (e.g., rotated) with respect to movable object 10. For example, carrier 16 may be a gimbal. Carrier 16 may be configured to allow payload 14 to be rotated about one or more axes, as described below. In some embodiments, carrier 16 may be configured to allow 360° of rotation about each axis to allow for greater control of the perspective of the payload 14. In other embodiments, carrier 16 may limit the range of rotation of payload 14 to less than 360° (e.g., ≤270°, ≤210°, ≤180, ≤120°, ≤90°, ≤45°, ≤30°, ≤15°, etc.), about one or more of its axes.

Communication device 20 may be configured to enable communications of data, information, commands (e.g., flight commands, commands for operating payload 14, etc.), and/or other types of signals between electronic control unit 22 and off-board entities. Communication device 20 may include one or more components configured to send and/or receive signals, such as receivers, transmitters, or transceivers that are configured to carry out one- or two-way communication. Components of communication device 20 may be configured to communicate with off-board entities via one or more communication networks, such as networks configured for WLAN, radio, cellular (e.g., WCDMA, LTE, etc.), WiFi, RFID, etc., and using one or more wireless communication protocols (e.g., IEEE 802.15.1, IEEE 802.11, etc.), and/or other types of communication networks or protocols usable to transmit signals indicative of data, information, commands, control, and/or other signals. Communication device 20 may be configured to enable communications with user input devices, such as a control terminal (e.g., a remote control) or other stationary, mobile, or handheld control device, that provide user input for controlling movable object 10 during flight. For example, communication device 20 may be configured to communicate with a second object 26, which may be a user input device or any other device capable of receiving and/or transmitting signals with movable object 10.

Second object 26 may be a stationary device, mobile device, or another type of device configured to communicate with movable object 10 via communication device 20. For example, in some embodiments, the second object 26 may be another movable object (e.g., another UAV), a computer, a terminal, a user input device (e.g., a remote control device), etc. Second object 26 may include a communication device 28 configured to enable wireless communication with movable object 10 (e.g., with communication device 20) or other objects. Communication device 28 may be configured to receive data and information from communication device 20, such as operational data relating to, for example, positional data, velocity data, acceleration data, sensory data (e.g., imaging data), and other data and information relating to movable object 10, its components, and/or its surrounding environment. In some embodiments, second object 26 may include control features, such as levers, buttons, touchscreen device, displays, etc. In some embodiments, second object 26 may embody an electronic communication device, such as a smartphone or a tablet, with virtual control features (e.g., graphical user interfaces, applications, etc.).

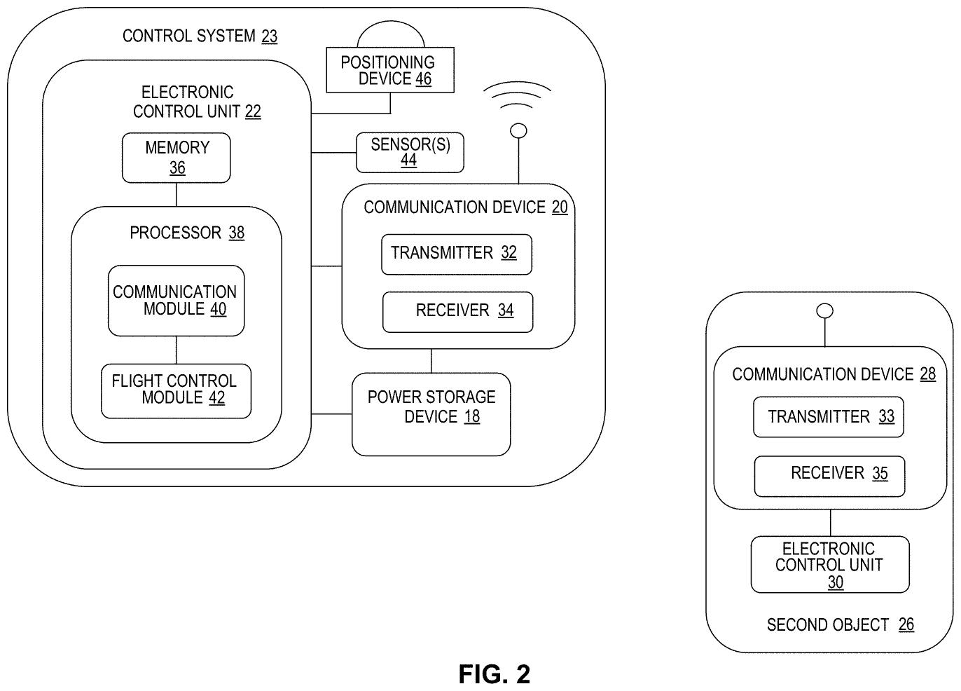

FIG. 2 is a schematic block diagram showing an exemplary control system 23 and second object 26 in accordance with the disclosed embodiments. Control system 23 may include the power storage device 18, communication device 20, and electronic control unit 22, among other things. Second object 26 may include, inter alia, a communication device 28 and an electronic control unit 30.

Power storage device 18 may be a device configured to energize or otherwise supply power to electronic components, mechanical components, or combinations thereof in the movable object 10. For example, power storage device 18 may be a battery, a battery bank, or other device. In other embodiments, power storage device 18 may be or include one or more of a combustible fuel, a fuel cell, or another type of power storage device.

Communication device 20 may be an electronic device configured to enable wireless communication with other devices and may include a transmitter 32, receiver 34, circuitry, and/or other components. Transmitter 32 and receiver 34 may be electronic components respectively configured to transmit and receive wireless communication signals. In some embodiments, transmitter 32 and receiver 34 may be separate devices or structures. Alternatively, transmitter 32 and receiver 34 may be combined (or their respective functions may be combined) in a single transceiver device configured to send (i.e., transmit) and receive wireless communication signals, which may include any type of electromagnetic signal encoded with or otherwise indicative of data or information. Transmitter 32 and receiver 34 may be connected to one or more shared antennas, such as the exemplary antenna in FIG. 2, or may transmit and receive using separate antennas or antenna arrays in the movable object 10.

Communication device 20 may be configured to transmit and/or receive data from one or more other devices via suitable means of communication usable to transfer data and information to or from electronic control unit 22. For example, communication device 20 may be configured to utilize one or more local area networks (LAN), wide area networks (WAN), infrared systems, radio systems, Wi-Fi networks, point-to-point (P2P) networks, cellular networks, satellite networks, and the like. Optionally, relay stations, such as towers, satellites, or mobile stations, can be used, as well as any other intermediate nodes that facilitate communications between the movable object 10 and second object 26. Wireless communications can be proximity dependent or proximity independent. In some embodiments, line-of-sight may or may not be required for communications.

Electronic control unit 22 may include one or more components, including, for example, a memory 36 and at least one processor 38. Memory 36 may be or include non-transitory computer readable media and can include one or more memory units of non-transitory computer-readable media. Non-transitory computer-readable media of memory 36 may be or include any type of volatile or non-volatile memory including without limitation floppy disks, hard disks, optical discs, DVDs, CD-ROMs, microdrive, magneto-optical disks, ROMs, RAMs, EPROMs, EEPROMs, DRAMs, VRAMs, flash memory devices, magnetic or optical cards, nanosystems (including molecular memory integrated circuits), or any other type of media or device suitable for storing instructions and/or data. Memory units may include permanent and/or removable portions of non-transitory computer-readable media (e.g., removable media or external storage, such as an SD card, RAM, etc.).

Information and data from sensory devices 19 and/or other devices may be communicated to and stored in non-transitory computer-readable media of memory 36. Non-transitory computer-readable media associated with memory 36 also may be configured to store logic, code and/or program instructions executable by processor 38 to perform any of the illustrative embodiments described herein. For example, non-transitory computer-readable media associated with memory 36 may be configured to store computer-readable instructions that, when executed by processor 38, cause the processor to perform a method comprising one or more steps. The method performed by processor 38 based on the instructions stored in non-transitory computer-readable media of memory 36 may involve processing inputs, such as inputs of data or information stored in the non-transitory computer-readable media of memory 36, inputs received from second object 26, inputs received from sensory devices 19, and/or other inputs received via communication device 20. The non-transitory computer-readable media may be configured to store data obtained or derived from sensory devices 19 to be processed by processor 38 and/or by second object 26 (e.g., via electronic control unit 30). In some embodiments, the non-transitory computer-readable media can be used to store the processing results produced by processor 38.

Processor 38 may include one or more processors and may embody a programmable processor, such as a central processing unit (CPU). Processor 38 may be operatively coupled to memory 36 or another memory device configured to store programs or instructions executable by processor 38 for performing one or more method steps. It is noted that method steps described herein may be embodied by one or more instructions and data stored in memory 36 and that cause the method steps to be carried out when processed by the processor 38.

In some embodiments, processor 38 may include, or alternatively may be operatively coupled to, one or more control modules, such as a communication module 40 and a flight control module 42 in the illustrative embodiment of FIG. 2, described further below. Communication module 40 may be configured to help control aspects of wireless communication between movable object 10 and other objects (e.g., second object 26), such as a transmission power level of communication device 20. Flight control module 42 may be configured to help control propulsion assemblies 12 of movable object 10 to adjust the position, orientation, velocity, and/or acceleration of movable object 10 during flight. Communication module 40 and flight control module 42 may be implemented in software for execution on processor 38, or may be implemented in hardware and/or software components at least partially included in, or separate from, the processor 38. For example, communication module 40 and flight control module 42 may include one or more CPUs, ASICs, DSPs, FPGAs, logic circuitry, etc. configured to implement their respective functions, or may share processing resources in processor 38. As used herein, the term “configured to” should be understood to include hardware configurations, software configurations (e.g., programming), and combinations thereof, including when used in conjunction with or to describe any controller, electronic control unit, or module described herein.

The components of electronic control unit 22 can be arranged in any suitable configuration. For example, one or more of the components of the electronic control unit 22 can be located on movable object 10, carrier 16, payload 14, second object 26, sensory device 19, or an additional external device in communication with one or more of the above. In some embodiments, one or more processors or memory devices can be situated at different locations, such as on the movable object 10, carrier 16, payload 14, second object 26, sensory device 19, or on an additional external device in communication with one or more of the above, or suitable combinations thereof, such that any suitable aspect of the processing and/or memory functions performed by the system can occur at one or more of the aforementioned locations.

Second object 26 may include the same or similar components as control system 23 in structure and/or function. For example, communication device 28 of second object 26 may include a transmitter 33 and a receiver 35. Transmitter 33 and receiver 35 may be the same or similar to transmitter 32 and receiver 34, respectively, in structure and/or function and therefore will not be described in detail. Electronic control unit 30 of second object 26 may be the same or similar to electronic control unit 22 in structure (e.g., may include memory, a processor, modules, etc.) and/or function and therefore will not be described in detail.

Control system 23 may receive information (“flight status information” or “status information”) relating to flight parameters of movable object 10. The status information may include information indicative of at least one of a movement and a position of the movable object, for example, while the movable object 10 is in flight or at rest. For example, the status information may include one or more of a speed, an acceleration, a heading, or a height (e.g., height above ground, altitude, etc.) of movable object 10, but is not limited thereto and may include other or additional information. Status information may be detected or collected via one or more sensors 44 included in, connected to, or otherwise associated with control system 23. For simplicity, only one exemplary sensor 44 is shown in FIG. 2. At least one sensor 44 may be included in the sensory devices 19. Sensors 44 may include, for example, gyroscopes, accelerometers, gyroscopes, magnetometers, pressure sensors (e.g., absolute pressure sensors, differential pressure sensors, etc.), and one or more (e.g., a plurality of) distance sensors, which may include one or more cameras, infrared devices, ultraviolet devices, x-ray devices, ultrasonic devices, radar devices, laser devices, and devices associate with a positioning system (e.g., a global positioning system (GPS), GLONASS, Galileo, Beidou, GAGAN, GNSS, etc.). Distance sensors may be configured to generate signals indicative of a distance between itself and other objects (e.g., second object 26), the ground, etc. Sensors 44 may include other or additional sensors, such as temperature sensors (e.g., thermometers, thermocouples, etc.), motion sensors, inertial measurement sensors, proximity sensors, image sensors, etc.

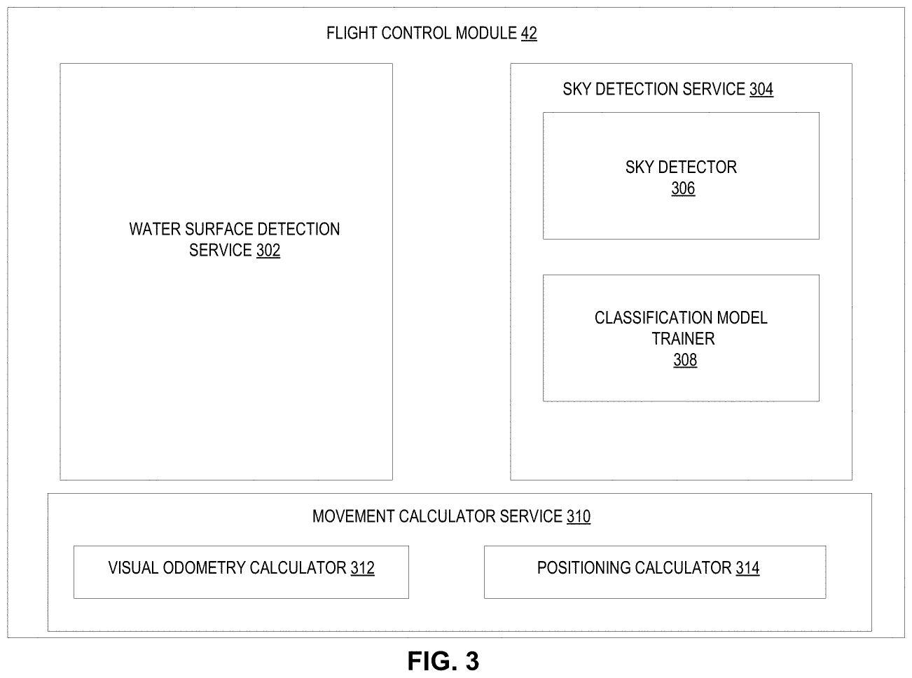

FIG. 3 is a schematic block diagram depicting an exemplary flight control module 42 in accordance with the disclosed embodiments. Flight control module 42 may include, among other things, at least one of a water surface detection service 302, a sky detection service 304, and a movement calculator service 310. In some embodiments, the sky detection service 304 may include a sky detector 306 and/or a classification model trainer 308. In some embodiments, the movement calculator service 310 may include a visual odometry calculator 312 and/or a positioning calculator 314.

The water surface detection service 302, sky detection service 304, sky detector 306, classification model trainer 308, movement calculator service 310, visual odometry calculator 312, and positioning calculator 314 may be implemented in software for execution on processor 38 (FIG. 2), or may be implemented in hardware and/or software components at least partially included in, or separate from, the processor 38. For example, any of the water surface detection service 302, sky detection service 304, sky detector 306, classification model trainer 308, movement calculator service 310, visual odometry calculator 312, and positioning calculator 314 may include one or more CPUs, ASICs, DSPs, FPGAs, logic circuitry, etc. configured to implement their respective functions, or may share processing resources in processor 38.

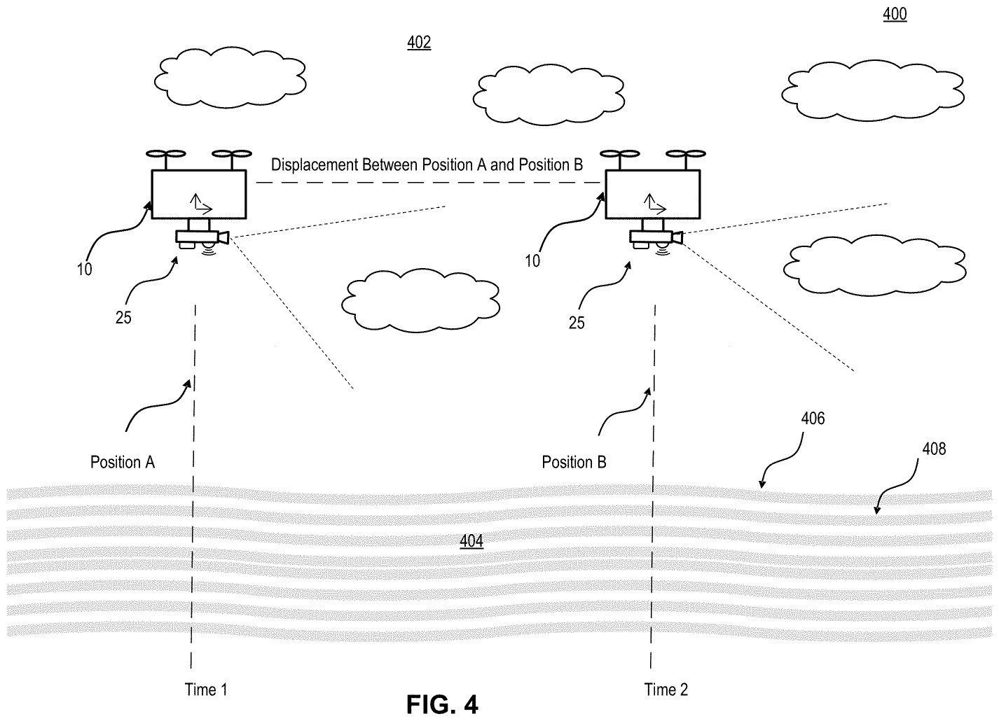

Water surface detection service 302 may allow movable object 10 to detect whether the movable object 10 encounters a water surface, for example, based on images captured by one or more cameras 19 in image system 25. Similarly, sky detection service 304 may allow movable object 10 to detect whether the movable object 10 encounters a sky based on images captured by one or more cameras. Water surface detection service 302 and sky detection service 304 may process one or more images captured by imaging system 25 to detect whether the movable object 10 encounters a water surface 404 or sky 402, such as shown in FIG. 4. Water surface detection service 302 may process images captured continuously, periodically, or on-demand by imaging system 25 during operation of movable object 10 to detect a water surface.

In some embodiments, sky detection service 304 may include sky detector 306 and classification model trainer 308. Sky detector 306 may use a classification model that the classification model trainer 308 trains using training parameters or other data to allow movable object 10 to detect a sky. In some embodiments, sky detector 306 may provide the training parameters or other data to the classification model trainer 308, which uses the training parameters to train the classification model continuously, periodically, or on-demand during operation of movable object 10. Training parameters may include values, such as RGB values, local binary pattern values, intensity values, etc. In some embodiments, each value of the training parameters may correspond to one or more pixels in the image. The classification model trainer 308 may obtain the training parameters from an external resource, such as an application programmable interface (API) or database, via communication device 20. In addition, classification model trainer 308 may train the classification model using machine learning principles, such as supervised learning, semi-supervised learning, and/or unsupervised learning. Sky detection service 304 may process images captured continuously, periodically, or on-demand by imaging system 25 during operation of movable object 10 to detect a sky.

In some embodiments, movement calculator service 310 may include a visual odometry calculator 312 and a positioning calculator 314. Movement calculator service 310 may provide instructions to the movable object 10 to allow movable object 10 (e.g., via assemblies 12 and/or rotary components 24) to move or navigate through an environment without assistance from second object 26. Movement calculator service 310 may allow movable object 10 to complete navigational tasks, such as braking, hovering, avoiding objects, etc. In some embodiments, movement calculator service 310 may use one or more determinations made by the water surface detection service 302 and/or sky detection service 304 to complete navigational tasks. For example, in some embodiments, movement calculator service 310 may ignore determinations by visual odometry calculator 312 and positioning calculator 314 based on one or more determinations made by the water surface detection service 302 and/or sky detection service 304 to complete navigational tasks. In addition, in some embodiments, movement calculator service 310 may utilize outputs from visual odometry calculator 312 to verify outputs of positioning calculator 314, or vice-versa, to allow movable object 10 to navigate through an environment and/or complete navigational tasks. Movement calculator service 310 may calculate status information during the operation of movable object 10.

Visual odometry calculator 312 may calculate status information using one or more images from imaging system 25. In certain embodiments, visual odometry calculator 312 may calculate a depth map using the images from imaging system 25 to allow movable object 10 to perform navigational tasks. Visual odometry calculator 312 may use a variety of techniques to calculate the depth map, such as global, semi-global, or neighborhood matching.

Positioning calculator 314 may work with, or independently from, visual odometry calculator 312 to allow movable object 10 to calculate status information or perform navigational tasks. Positioning calculator 314 may obtain positional data from one or more sensors 44. For example, positioning calculator 314 may obtain GPS data from a GPS sensor 44. GPS data may allow positioning calculator 314 to calculate movable object 10's position (e.g., coordinate position) in the environment. Positioning calculator 314 may use an inertial measurement unit (IMU), not depicted, to obtain IMU data. An IMU may include one or more sensors 44, such as one or more accelerometers, gyroscopes, pressure sensors, and/or magnetometers. IMU data may allow positioning calculator 314 to calculate movable object 10's acceleration, velocity, angular rate, etc. about its various axes, magnetic field strength surrounding movable object 10, etc.

FIG. 4 is a diagram illustrating an exemplary image capture process that may be used as movable object 10 moves from a first Position A to a second Position B in an exemplary environment 400. Environment 400 may include, for example, a sky 402 and body of water 404. Sky 402 may include the celestial dome, that is, everything that lies above the surface of the Earth, including the atmosphere and outer space. In some embodiments, sky 402 may include, similar to Earth, everything that lies above the surface of other planets, asteroids, moons, etc., including their atmospheres and outer space.

Body of water 404 may include a large accumulation of water, such as an ocean, pond, sea, lake, wetland, reservoir, etc., or a small accumulation of water, such as a puddle, pool, container of water, etc. In addition, body of water 404 may exist on Earth or on another planet and/or be natural or unnatural. While the disclosed embodiments refer to a body of water, those skilled in the art will appreciate the systems and methods described herein may apply to other types of liquids or materials that are not rich in texture when they are imaged by an imaging system. In the disclosed embodiments, body of water 404 includes a water surface 406. Water surface 406 may, at any given time, appear smooth or choppy. When water surface 406 appears choppy, water surface 410 may include a wave 408 (e.g., or a ripple on the water surface). Wave 408 may be produced by a variety of circumstances, such as but not limited to wind gusts or air turbulence resulting from operation of movable object 10.

As shown in FIG. 4, movable object 10 may utilize imaging system 25 to capture one or more images at Position A at a first time (“Time 1”). If multiple images are captured at Position A, imaging system 25 may capture the images simultaneously or near-simultaneously at Time 1. In some embodiments, for example, if a single image is captured at Position A, movable object 10 may cause imaging system 25 to quickly capture another image at a position in close proximity to Position A (not pictured). Likewise, movable object 10 may utilize imaging system 25 to capture one or more images at Position B at a second time (“Time 2”). If multiple images are captured at Position B, imaging system 25 may capture the images simultaneously or near-simultaneously at Time 2. For example, if a single image is captured at Position B, movable object 10 may cause imaging system 25 to quickly capture another image in close proximity to Position B (not pictured). Imaging system 25 may capture the images using a multi-camera, stereovision, or single camera system. Solely for purposes of clarity and explanation, the disclosed embodiments are described in terms of an exemplary imaging system 25 that employs a stereovision system, e.g., with multiple cameras. In the disclosed embodiments, movable object 10 may compare a set of one or more images captured at Position A and another set of one or more images captured at Position B to navigate through environment 400. Comparing the images captured at Positions A and B may allow movable object 10 to calculate status information and/or complete certain navigation tasks needed for maneuvering in environment 400.

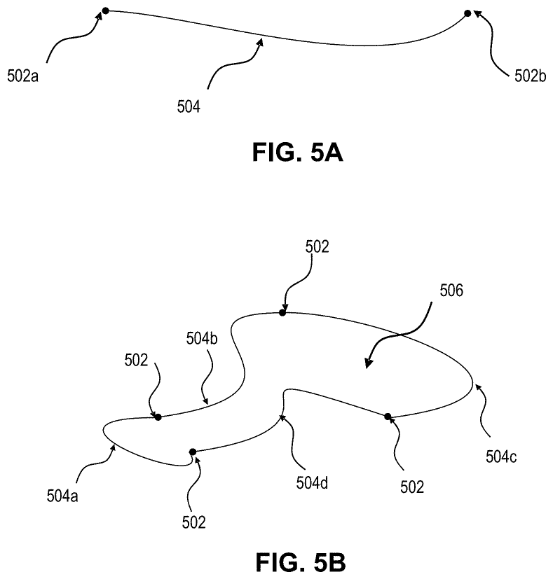

FIG. 5A is a schematic diagram depicting an exemplary edge line 504, for example, corresponding to an exemplary wave 408 in images captured by movable object 10 in accordance with the disclosed embodiments. Movable object 10 may determine that it is encountering a body of water 404 by detecting wave 408 on water surface 406. To detect wave 408, movable object 10 may identify an edge line 504 and/or one or more edge points 502a and 502b. Edge points 502a and 502b may be the endpoints of edge line 504, as shown in FIG. 5A.

FIG. 5B is a schematic diagram depicting an exemplary light spot 506 that may be detected on the exemplary water surface 406, such as on a wave 408, in accordance with the disclosed embodiments. Wave 408 of water surface 406 may include one or more light spots 506, e.g., corresponding to an area on the surface where sun light is concentrated or reflected. In other embodiments, light spot 506 may correspond to any region of the water surface 406 that is distinguishable in the image information corresponding to the body of water. In the disclosed embodiment, for example, light spot 506 may be produced when light is reflected off of wave 408. Light spot 506 is an area that is enclosed by one or more edge lines 504. In this example, light spot 506 is bounded by a closed contour consisting of edge lines 504a, 504b, 504c, and 504d. Edge lines 504a-d may have one or more edge points 502. Edge points 502 may serve as connection points between adjacent edge lines 504a-d.

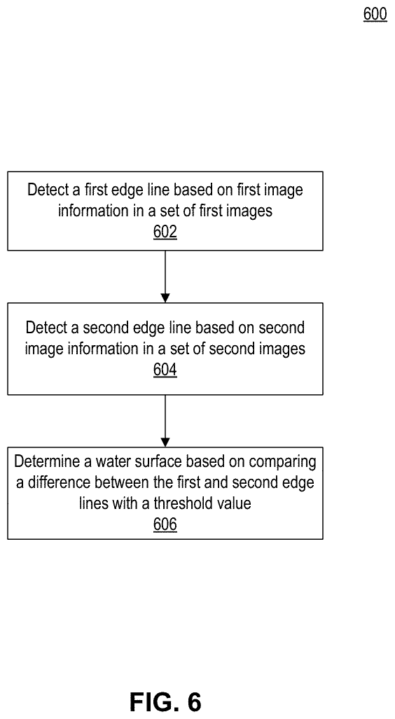

FIG. 6 is a flowchart illustrating an exemplary water surface detection process 600 that may be used in accordance with the disclosed embodiments. Movable object 10 may execute water surface detection process 600 using one or more services of flight control module 42. For example, movable object 10 may use water surface detection service 302 to execute the water surface detection process 600. Movable object 10 also may use one or more APIs and/or external resources to execute one or more steps of water surface detection process 600.

As shown in FIG. 6, at step 602, movable object 10 may detect a first edge line based on first image information in a first set of images. Movable object 10 may capture the first set of images, for example, by using imaging system 25 to capture the first set of images at a Position A at Time 1 as illustrated by FIG. 4. In exemplary process 600, movable object 10 may use one or more images in the first set of images. For purposes of clarity, process 600 will be described below as using one image in the first set of images. The first image information may include data that represents the image, such as pixel information representing each pixel in the image. The pixel information may have values, such as RGB values indicating the color of each pixel in the image. Pixel information values additionally or alternatively may include local binary pattern (LBP) values to provide the texture of an image. In some embodiments, other values may be included in the first image information, such as but not limited to an intensity of each pixel, a number of pixels, a position of each pixel, etc.

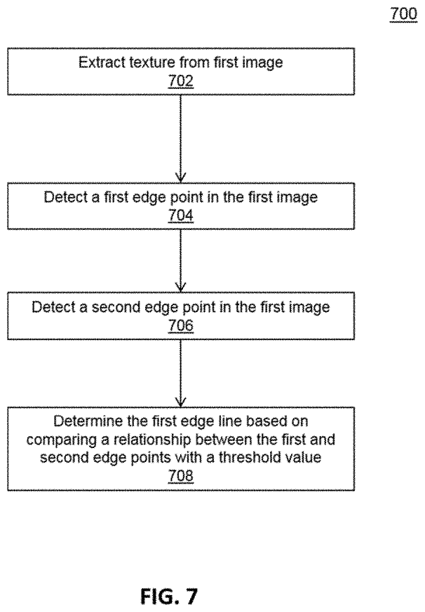

To detect a first edge line based on the first image information in the set of first images at step 602, movable object 10 may employ the exemplary edge line detection process 700 illustrated in FIG. 7. For example, at step 702, movable object 10 may extract texture information for a first image in the first set of images. To extract the texture information, movable object 10 may obtain a gradient direction and gradient magnitude of the image using one or more conventional methods. In some embodiments, for example, movable object 10 may use a Sobel operator, Canny operator, Prewitt, convolution kernel, convolutional neural network (commonly referred to as CNN), etc. to obtain the gradient direction and gradient magnitude. Movable object 10 may transform data in the first image and/or data representing the first image using the gradient direction and magnitude. In some embodiments, movable object 10 may skip step 702 if the movable object determines the texture of the image has already been or does not need to be extracted. Movable object 10, for example, may determine texture information does not need to be extracted from the first image if objects in the image can be readily identifiable or meet certain thresholds or criteria to make them readily identifiable.

At step 704, movable object 10 may detect a first edge point in the first image. An edge point may be comprised of one or pixels. Similarly, at step 706, movable object 10 may detect a second edge point in the first image. Using the first and second edge points, at step 708, movable object 10 may determine a first edge line based on comparing a relationship (e.g., distance) between the first and second edge points with a threshold relationship (e.g., threshold distance value). In some embodiments, movable object 10 may determine a first edge line in the image when the distance between the first and second edge points is less than a threshold value, or vice-versa.

In some embodiments, movable object 10 may loop through steps 702-708 before determining the first edge line. The threshold value may be, for example, a predetermined value or may be dynamically determined for different iterations of steps 702-708. In some embodiments, for example, movable object 10 may decrease the threshold value or start with a smaller threshold value than the initial threshold value if movable object 10 determines the threshold value requires refinement, e.g., based on prior edge-line calculations.

Returning to FIG. 6, at step 604, movable object 10 may detect a second edge line based on second image information in a second set of images. Movable object 10 may capture the second set of images, for example, using imaging system 25 to capture the second set of images at a Position B at Time 2 as illustrated in FIG. 4. The second edge line may correspond to the first edge line (captured at step 602). In such embodiments, movable object 10 may find the edge line that most resembles the first edge line that it detected in the first set of images in order to detect the second edge line in the second set of images. Movable object 10 may use one or more edge points of the first edge line or first image information associated with the first edge line to identify or target the second edge line in the second image information. Movable object 10 may detect the second edge line based on the second image information in the second set of images using the same or similar exemplary steps shown in FIG. 7 and described above.

At step 606, movable object 10 may determine a water surface based on comparing a difference between the first and second edge lines with a threshold value. Here, the threshold value may indicate a difference between the first and the second edge lines. For example, the threshold value may indicate a difference in position, area, rotation, etc. of the first and second edge lines. Thus, in some embodiments, movable object 10 may determine a water surface 406 based on determining that the change in orientation or rotation of the first and second edge lines is less than a threshold value. In some embodiments, movable object 10 may compare the difference between the first and second edge lines by superimposing the first edge line in the first image taken at Position A onto the second edge line in the second image taken at Position B. In some embodiments, movable object 10 may use GPS data from GPS sensor 44 or IMU data from an IMU unit. Movable object 10 may use conventional spatial reconstruction to superimpose the first image onto the second image to compare the difference between the first and second edge lines.

In addition to or in the place of detecting a first edge line based on first image information in a set of first images, detecting a second edge line based on second image information in a set of second images, and determining a water surface based on comparing a difference between the first and second edge lines with a threshold value; movable object 10 may determine a water surface based on a light spot on the water surface. For example, movable object 10 may detect a light spot based on first image information in a set of first images (similar to step 602), detect a light spot based on second image information in a set of second images (similar to step 604), and determine a water surface based on comparing a difference between the first and second light spots with a threshold value (similar to step 606).

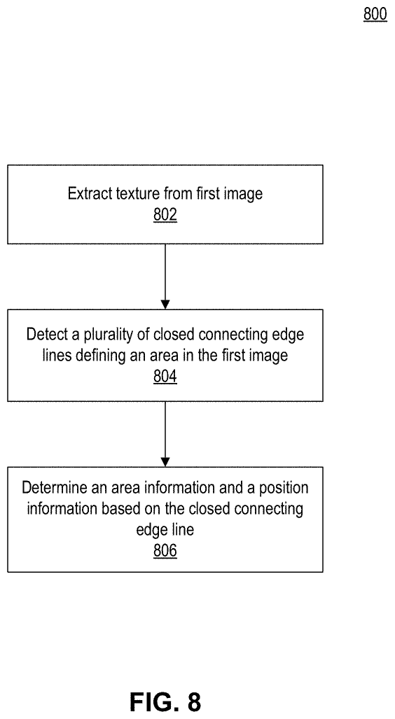

However, detecting a first or second light spot may include additional steps, such as the exemplary steps illustrated in FIG. 8. At step 802, movable object 10 may extract texture from a first image (or second image) using techniques similar to those described above at step 702. At step 804, movable object 10 may detect a plurality of closed connecting edge lines that define an area in the first image (or second image). Movable object 10 may repeat steps 704-708 in FIG. 7 to detect each of a plurality of edge lines and, then, determine a set of detected edge lines that form a perimeter around an area in the first (or second) image. In such disclosed embodiments, the area within the perimeter formed by the closed connected edge lines defines the light spot. At step 806, movable object 10 may determine status information related to the enclosed area, which may be a light spot. This status information, for example, may include area information or position information corresponding to the light spot or closed connecting edge lines. It should be understood that movable object may detect a second light spot corresponding to a detected first light spot, similarly as described above in relation to detecting a second edge line corresponding to a detected first edge line. After the first and second light spots are detected, movable object 10 may determine a water surface 406 based on comparing a difference between the first and second light spots with a threshold value (similar to step 606). For example, movable object 10 may compare the difference between the first and second light spots by superimposing the first light spot in the first image taken at Position A onto the second light spot in the second image taken at Position B.

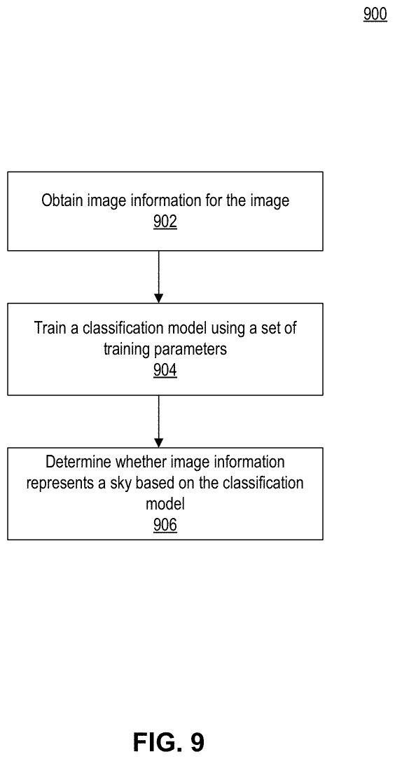

FIG. 9 is a flowchart depicting sky detection process 900 that may be used in accordance with the disclosed embodiments. At step 902, movable object 10 may obtain image information for an image. For example, movable object 10 may obtain image information for an image that was captured using one or more cameras, whether internal or external to the system. In some embodiments, movable object 10 may obtain the image information by retrieving it from a database (e.g., either located on movable object 10 or externally in a remote database) or using any of the above-described ways to obtain image information, such as described with reference to FIG. 4.

At step 904, movable object 10 may train a classification model using a set of training parameters. In the disclosed embodiments, for example, the training parameters may include values, such as one or more of RGB values, local binary pattern values, intensity values, etc. Each value may correspond to one or more pixels in the image. The training parameters may be used to train the classification model so it may process an image's image information to distinguish which region(s) of the image corresponds to sky relative to other objects or features in the image. In certain embodiments, movable object 10 may obtain the training parameters from an external source, such as an API or database, via communication device 20. In addition, movable object 10 may train the classification model using machine learning principles, such as supervised learning, semi-supervised learning, and/or unsupervised learning. In some embodiments, movable object 10 may train the classification model using a support vector machine. Movable object 10 may also a support vector machine that uses a Gaussian kernel process to train the classification model.

At step 906, movable object 10 may determine whether the image information represents a sky based on the classification model. For example, movable object 10 may capture images continuously, periodically, or on-demand, and collect the captured image information from imaging system 25. Movable object 10 may provide the collected image information for a captured image to the classification model, which in turn uses the image information to determine one or more regions of the image corresponding to a sky. In some embodiments, steps 902-906 may be applied to multiple captured images, for example, that are averaged or otherwise combined before their image information is processed by the classification model to detect a sky in accordance with the exemplary steps of FIG. 9.

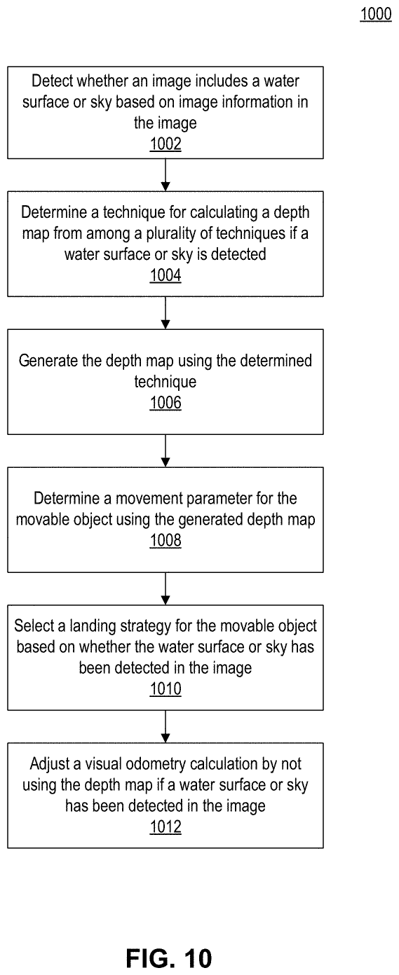

FIG. 10 is a flowchart illustrating an exemplary process 1000 that may be used for detecting a water surface or a sky in an image in accordance with the disclosed embodiments. Movable object 10 may perform the exemplary detection process 1000 using one or more services of flight control module 42. Movable object 10 also may use one or more APIs and/or external resources to perform one or more steps of the exemplary process 1000 for detecting a water surface or a sky in an image.

At step 1002, movable object 10 may detect whether an image includes a water surface or sky based on image information in the image using techniques similar to those described above in relation to FIGS. 6-9. At step 1004, movable object 10 may determine a technique for calculating a depth map from a plurality of techniques if a water surface or sky is detected in an image. The plurality of techniques may include one or more types of global matching, semi-global matching, or any other techniques to map similar neighboring pixels in constructing a depth map for the image. In some embodiments, for example, movable object 10 may determine to use a first particular technique, such as global matching, to create the depth map if a sky is detected and use a second particular technique, such as semi-global matching, to create the depth map if a water surface is detected. In some embodiments, the first and second particular techniques may be the same.

In some embodiments, semi-global matching techniques may not produce optimized results, such as when there is an empty sky, e.g., planes, birds, etc. in the sky. Thus, movable object 10 may set a cost parameter, e.g., equal to a predetermined value, to indicate pixels in such an area of the image without texture. In such implementations, the cost parameter may indicate the cost of a pixel along each path to a neighboring pixel when matching with a corresponding pixel in another image. Setting the pixels' cost parameters to a value indicating the pixels are in an area with little or no texture may cause movable object 10 to ignore image information corresponding to a detected water surface or sky with little or no texture when generating the depth map, at step 1006. Those skilled in the art will appreciate that the depth map may be generated using other techniques in cases where there is little or no texture in the detected regions of the water surface or sky. In some embodiments, the depth map may be determined without using the pixel values in areas of detected water surface or sky with little or no texture, e.g., instead interpolating or otherwise estimating depths based on pixel values surrounding the area with little or no texture.

At step 1008, movable object 10 may determine a movement parameter, e.g., representing at least one of status information, navigational tasks, or a direction or rotation in which movable object 10 may move. By way of example, and not limitation, the movement parameter may correspond to a rotation about one or more axes, moving in a particular direction, hovering, accelerating, decelerating (braking), changing altitude, changing flight modes, changing flight paths, and so forth.

In addition, at step 1010, movable object 10 may adjust its navigation strategy based on whether a water surface and/or sky has been detected in the image and/or the location of the detected water surface or sky in the image. In some embodiments, for example, movable object 10 may decide to use only GPS data and/or IMU data when navigating over a detected water surface or sky. In other embodiments, movable object 10 instead may decide to turn off or limit use of its braking or hovering operations when traveling over a detected region of a water surface or sky. For example, in some embodiments, movable object 10 may adjust its navigation strategy if a water surface is detected so it may refuse to land until it has passed the water surface or no longer detects a water surface below it.

At step 1012, movable object 10 may adjust a visual odometry calculation by not using a depth map if a water surface or sky has been detected in the image. In such cases, the movable object 10 may determine visual odometry instead by relying on GPS data or IMU data. For example, movable object 10 may adjust a visual odometry calculation by not using the depth map when a body of water is detected while movable object 10 is hovering. Movable object 10 may not use the depth map in this example because the depth map may produce instability while hovering.

In some embodiments, movable object 10 may skip or otherwise not complete one or more of the steps in the exemplary process 1000. For example, in some embodiments where the detected water surface or sky has insufficient texture, the movable object 10 may not perform steps of calculating a depth map (step 1004) and/or generating the depth map (step 1006). In such embodiments, movable object 10 may not perform one or more of these steps, for example, to reduce unnecessary processing operations in situations where generating a depth map may not be necessary or useful for completing one or more of the steps 1010-1012. For example, when movable object 10 detects an underlying water surface, movable object may not decide to generate a depth map and instead may alter or change its landing strategy and/or visual odometry calculation strategy without using a depth map.

In the exemplary steps and figures described above, image information may be organized by regions of an image. Therefore, in some embodiments, movable object 10 may use only image information related one or more regions in the image, which may increase the processing speed for movable object 10. For example, movable object 10 may process an image only from a subset of image information based on prior experiences with the environment, prior experiences with the image data, the navigational task that the movable object is trying to complete, status information that the movable object is trying to calculate, etc. In some embodiments, movable object 10 may use only certain regions in an image, for example, representing the bottom portion of an image when the movable object is trying to hover or it previously detected a water surface at a particular position or GPS location.

Modifications and adaptations of the embodiments will be apparent from consideration of the specification and practice of the disclosed embodiments. For example, the described implementations include hardware, firmware, and software, but systems and techniques consistent with the present disclosure may be implemented as hardware alone. Additionally, the disclosed embodiments are not limited to the examples discussed herein.

Computer programs based on the written description and methods of this specification are within the skill of a software developer. The various programs or program modules may be created using a variety of programming techniques. For example, program sections or program modules may be designed in or by means of Java, C, C++, assembly language, or any such programming languages. One or more of such software sections or modules may be integrated into a computer system, non-transitory computer-readable media, or existing communications software.

While illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps or inserting or deleting steps. It is intended, therefore, that the specification and examples be considered as exemplary only, with the true scope and spirit being indicated by the following claims and their full scope of equivalents.

What is claimed is:

1. A method for processing image information in an image to determine a movement for a movable object, the method comprising:
detecting whether the image includes a water surface or a sky based on the image information in the image; and
in response to detecting that the image includes the water surface or the sky:
determining a technique from a plurality of techniques for calculating a depth map;
generating the depth map using the technique; and
determining a movement parameter for the movable object using the depth map.

2. The method of claim 1, further comprising:
setting cost parameters of pixels corresponding to the detected water surface or sky to a predetermined value.

3. The method of claim 2, further comprising:
calculating the depth map such that depths associated with pixels corresponding to the detected water surface or sky are calculated based on depths of other pixels in a vicinity of the pixels corresponding to the detected water surface or sky.

4. The method of claim 1, wherein the movement parameter causes the movable object to perform at least one of a movement, a hover, an acceleration, a deceleration, a change in an altitude, a change in a flight mode, or a change in a flight path.

5. The method of claim 1, further comprising:
in response to detecting that the image includes the water surface or the sky:
selecting a navigation strategy for the movable object based on the detection of the water surface or the sky in the image.

6. The method of claim 5, wherein selecting the navigation strategy comprises selecting a landing strategy for the movable object without using the depth map in response to detecting the water surface in the image.

7. The method of claim 5, wherein selecting the navigation strategy comprises performing a visual odometry calculation for the movable object without using the depth map in response to detecting the water surface or the sky in the image.

8. A system for processing image information in an image to determine a movement for a movable object, the system comprising:
a memory that stores a set of instructions; and
a processor coupled to the memory and operative to execute the instructions to:
detect whether the image includes a water surface or a sky based on image information in the image; and
in response to detecting that the image includes the water surface or the sky:
determine a technique from a plurality of techniques for calculating a depth map in response to the water surface or the sky being detected in the image;
generate the depth map using the technique; and
determine a movement parameter for the movable object using the depth map.

9. The system of claim 8, wherein the processor is further operative to execute instructions to set cost parameters of pixels corresponding to the detected water surface or sky equal to a predetermined value.

10. The system of claim 8, wherein the processor is further operative to execute instructions to calculate the depth map such that depths associated with pixels corresponding to the detected water surface or sky are calculated based on depths of other pixels in a vicinity of the pixels corresponding to the detected water surface or sky.

11. The system of claim 8, wherein the movement parameter causes the movable object to perform at least one of a movement, a hover, an acceleration, a deceleration, a change in an altitude, a change in a flight mode, or a change in a flight path.

12. The system of claim 8, wherein the processor is further operative to execute the instructions to:
in response to detecting that the image includes the water surface or the sky:
select a navigation strategy for the movable object based on the detection of the water surface or the sky in the image.

13. The system of claim 12, wherein the processor is further operative to execute the instructions to select the navigation strategy by selecting a landing strategy for the movable object without using the depth map in response to detecting the water surface in the image.

14. The system of claim 12, wherein the processor is further operative to execute the instructions to select the navigation strategy by performing a visual odometry calculation for the movable object without using the depth map in response to detecting the water surface or the sky in the image.

15. A movable object, comprising:
one or more propulsion assemblies;
a memory storing a set of instructions; and
a processor coupled to the memory and operative to execute the instructions to:
detect whether the image includes a water surface or a sky based on image information in the image; and
in response to detecting that the image includes the water surface or the sky:
determine a technique from a plurality of techniques for calculating a depth map in response to the water surface or the sky being detected in the image;
generate the depth map using the technique; and
determine a movement parameter for the movable object using the depth map.

16. The movable object of claim 15, wherein the processor is further operative to execute the instructions to:
in response to detecting that the image includes the water surface or the sky:
select a navigation strategy for the movable object based on the detection of the water surface or the sky in the image.
